(19) United States
(12) Patent Application Publication
(10) Pub. No.: US 2024/0218647 A1
(43) Pub. Date: Jul. 4, 2024

(54) COUNTERTOP PROTECTOR

(71) Applicant: Jeremy DAROSS, Arlington, VA (US)

(72) Inventor: Jeremy DAROSS, Arlington, VA (US)

(21) Appl. No.: 18/289,052

(22) PCT Filed: Jun. 7, 2022
(86) PCT No.: PCT/US2022/032466

§ 371 Date: Oct. 31, 2023

Related U.S. Application Data
(60) Provisional application No. 63/208,647, filed on Jun. 9, 2021.

(51) Int. Cl. E03C 1/186; A47J 47/20

(52) U.S. Cl. CPC E03C 1/186; A47J 47/20

(57) ABSTRACT

The invention generally relates to a protective device that covers the front portion of a sink countertop, the edge of the countertop, and a sidewall of the sink basin, providing both protection of the finished stone from chipping or scratching by pots and pans as well as protection of dishes from chipping against the stone. The accompanying removable caddy provides a drainable storage location for a sponge within the basin of the sink.

### CROSS-REFERENCE TO RELATED APPLICATIONS

This application claims benefit of priority to U.S. Provisional Patent Application No. 63/208,647 filed Jun. 9, 2021, which is incorporated herein by reference in its entirety.

### FIELD OF THE INVENTION

The present invention relates to a removable device for protecting the countertop region adjacent a sink.

### SUMMARY

The present invention relates to a protective device that covers the front portion of a sink countertop, the edge of the countertop, and a sidewall of the sink basin, providing both protection of the finished stone from chipping or scratching by pots and pans as well as protection of dishes from chipping against the stone. The accompanying removable caddy provides a drainable storage location for a sponge within the basin of the sink.

In one aspect of the invention, a device for protecting the front counter portion of a countertop with an installed sink is disclosed. The sink has a sink basin and a faucet. The countertop has a front countertop portion running along an edge of the sink basin opposite the faucet. The device has a substantially flat top member where the width of the top member sized to substantially match a width of the front countertop portion perpendicular to the edge of the sink basin. The device also has a substantially flat front member connected to the top member, the front member and the top member forming an approximately 90-degree dihedral angle. And the device has a substantially flat back member connected to the top member. The back member and the top member form an approximately 90-degree dihedral angle. The length of the back member being less than the length of the sink basin. The back member lies substantially flat against a sidewall of the sink basin.

In one aspect of the invention, the front member lies substantially flat against an edge of the countertop.

In another aspect of the invention, the front member has holes with a circular portion and a neck portion. In another aspect, those holes are grommet holes. In another aspect of the invention, the device has a towel hook that allows a dish towel to hang from the hook and a stud where the stud is inserted into one of the holes in the front member. The stud has a narrowed portion that engages with the neck portion of the hole. In another aspect of the invention, the device has a towel bar component that allows a dish towel to hang from the bar and two studs. Each stud is inserted into one of the holes in the front member and each stud has a narrowed portion that engages with the neck portion of the hole.

In another aspect of the invention, the back member has holes with a circular portion and a neck portion. In another aspect, those holes are grommet holes. In another aspect, the device has a caddy to hold a sponge. The caddy has drainage holes and a stud where the stud is inserted into one of the holes in the back member. The stud has a narrowed portion that engages with the neck portion of the hole.

In another aspect of the invention, the device has walls located along edges of the top member to direct water on the top member into the adjoining sink basin.

In another aspect of the invention, the device has a ridge located along an edge of the back member. The ridge connected to a wall located along an edge of the top member to substantially lock the back member and top member into a right angle.

In another aspect of the invention, the device has ribs with a first segment disposed on the top member and a second segment disposed on the back member. The ribs help protect the area most likely to be hit by a pan.

In another aspect of the invention, the top member, the back member, the front member, the walls, the ridge, and the ribs are formed from a single molded silicone piece.

### BRIEF DESCRIPTION OF THE DRAWINGS

FIG. 1 is an isometric view of an embodiment of the flexible saddle of the invention, installed on a typical single bowl undermount kitchen sink in a stone countertop, with a caddy attached.

FIG. 2 is an isometric view of the saddle and caddy of FIG. 1.

FIG. 3 is an isometric view of the saddle of FIG. 1 without the caddy attached.

FIG. 4 is a plan view of the saddle of FIG. 1, without the caddy attached.

FIG. 5 is an elevation view of the saddle of FIG. 1, without the caddy attached, as seen from the interior of the sink.

FIG. 6 is an elevation view of the saddle of FIG. 1, without the caddy attached, as seen from the exterior of the sink.

FIG. 7 is an end view of the saddle of FIG. 1, without the caddy attached.

FIG. 8 is an isometric view of the caddy of FIG. 1.

FIG. 9 is a plan view of the caddy of FIG. 1.

FIG. 10 is an elevation view of the caddy of FIG. 1, as seen from the interior of the sink.

FIG. 11 is a section view of the caddy of FIG. 10 viewed along line A-A.

FIG. 12 is an isometric view of an extra-long version of the saddle, for use with wider sinks.

FIG. 13 is a plan view of the extra-long saddle of FIG. 12.

FIG. 14 is an isometric view of a second embodiment of the saddle, with holes on both sides.

FIG. 15 is a plan view of the embodiment of the saddle shown in FIG. 14.

FIG. 16 is an elevation view of the saddle of FIG. 14, without the caddy attached, as seen from the exterior of the sink.

FIGS. 17a-17d are isometric, end, elevation, and plan views of a hook for use with the saddle of FIG. 14.

FIGS. 18a and 18b are elevation and isometric views of a towel bar for use with the saddle of FIG. 14.

### DETAILED DESCRIPTION

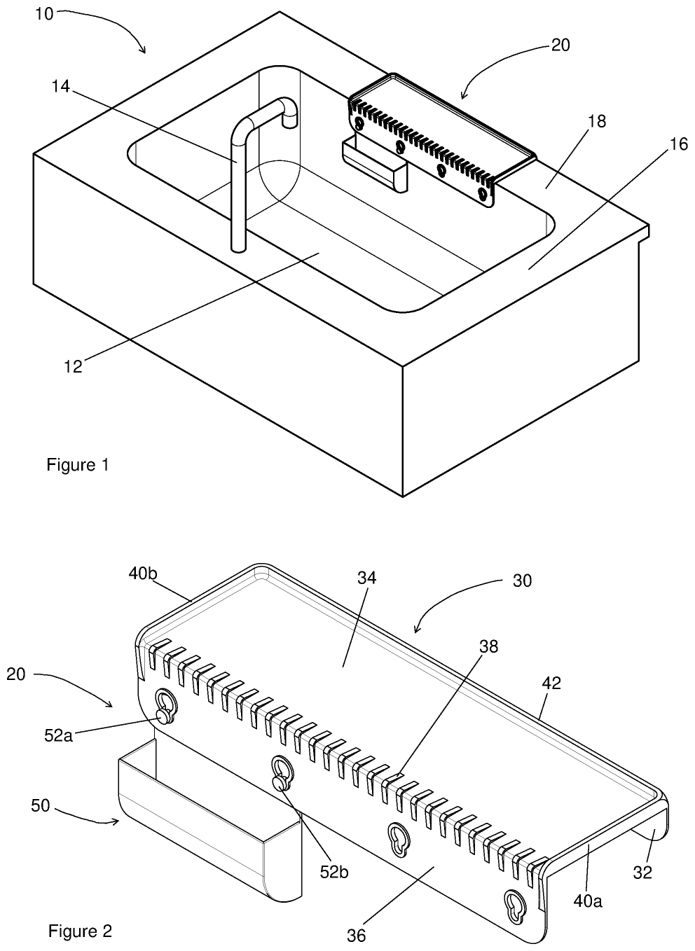

Referring to FIG. 1, an undermount sink 10 includes a basin 12 and a faucet 14. A sink countertop 16 surrounds sink basin 12 and includes a front countertop portion 18. The front countertop portion 18 is the portion of sink countertop 16 situated between where a user of the sink would normally stand when using the sink and the sink basin 12. The countertop can be made of, e.g., granite, quartz, marble, slate, or wood, or other countertop materials known to those of skill in the art. Basin 12 includes a bottom portion where the sink drain is located (not shown) and sidewalls surrounding the bottom portion.

A flexible, removable protector 20 covers the front countertop portion 18 and a portion of the basin sidewall located opposite faucet 14. Referring to FIG. 2, protector 20 includes a saddle member 30 and a removable caddy 50. Saddle member 20 allows a user to place a dish or pan being washed by hand on the saddle without the dish or pan contacting the underlying countertop thereby protecting the countertop from chipping or damage when the dish or pan is being washed.

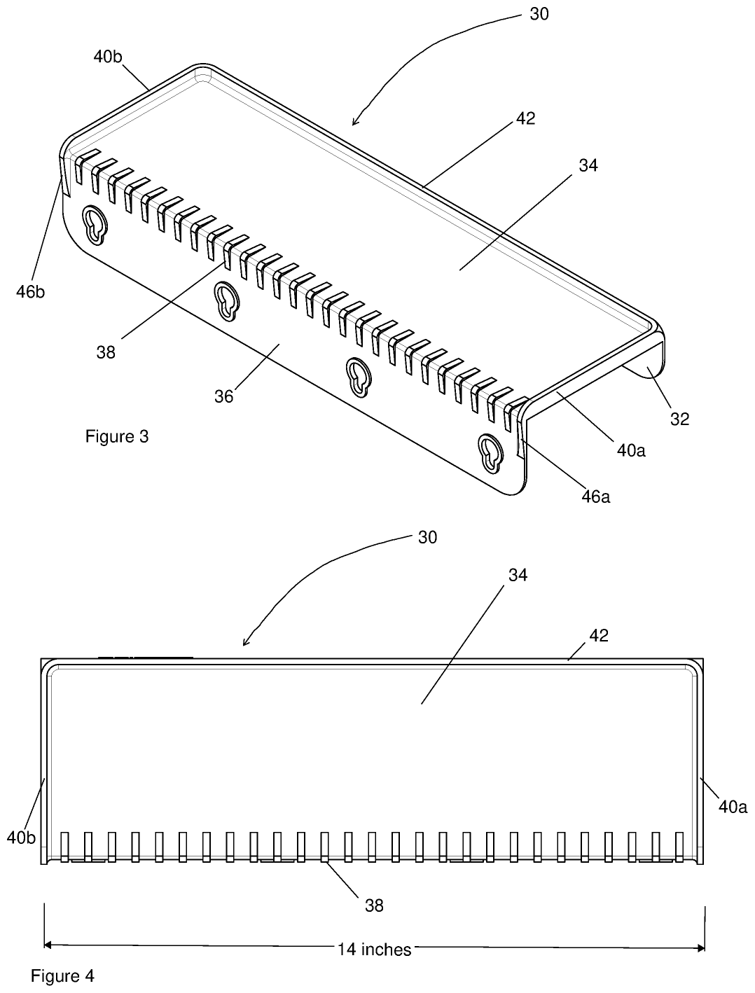

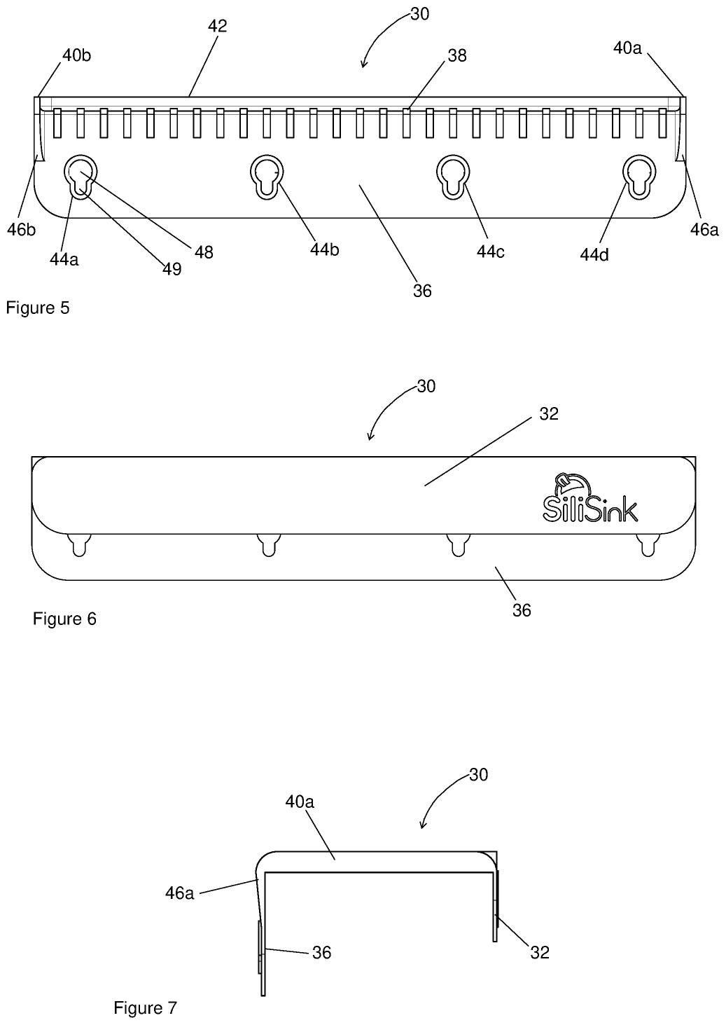

Referring to FIGS. 2-7, the saddle 30 includes front member 32, top member 34, and back member 36. Top member 34 is a substantially flat rectangular surface designed to sit on top of front countertop portion 16 as shown in FIG. 1 The width of top member 34 is sized to substantially match, i.e., a difference less than one inch, the width of the front countertop portion 16. Top member 34 generally forms an approximate right dihedral angle, i.e., 90°±5°, with front member 32 and back member 36. Front member 32 is substantially flat and substantially rectangular, e.g. a rectangular shape with rounded corners. The height of front member 32 can be made to substantially match the thickness of sink countertop 16. Back member 36 is also substantially flat and designed to lie flat against a portion of the basin sidewall located opposite faucet 14. When the saddle 30 is placed over the front countertop portion 18, as shown in FIG. 1, members 32 and 36 and top member 34 provide a barrier, protecting front countertop portion 18 of the sink from chipping or damage from impacts with pots and pans, and protecting dishes from impacts with the hard front countertop portion 18. Back member 36 has ridges, 46a and 46b, as shown in FIG. 5 and FIG. 7, that run along the side edges of back member 36. Ridges 46a and 46b together with side dam walls 40a and 40b function to lock the angle between top member 34 and back member 36 at an approximate right dihedral angle, i.e., 90°±5°. This substantially prevents saddle from sliding out of sink basin 12. Saddle 30 includes front dam wall 42 which together with side dam walls 40a and 40b functions to lock the angle between top member 34 and front member 32 at an approximate right dihedral angle, i.e., 90°±5°. This substantially prevents saddle from sliding into sink basin 12.

In operation, a user washing for example a pan would place the pan on top member 34 of the saddle instead of directly on countertop 16, thereby protecting countertop 16 from damage when the pan is being washed by the user. The top surface of top member 34 is surrounded by side dam walls 40a and 40b and front dam wall 42 on three sides. The side dam walls and front dam wall prevent water on the surface of top member 34 from flowing off the sides or the front of saddle 30, redirecting water on the surface of top member 34 into sink basin 12. Side dam walls 40a and 40b and front dam wall 42 rise approximately a quarter inch above the top surface of top member 34. Another advantage in having front dam wall 42 but no wall on the sink basin side of top member 34 is that when a pan is placed onto top member 34 and front dam wall 42, the pan will be inclined towards the sink basin 12. Water on or in the pan will naturally flow towards sink basin 12 due to this inclination. To achieve this inclination of the pan, the length of saddle 30 must generally be greater than the diameter of a typical cookware bottom. In one embodiment, the length of the saddle is 14 inches or greater.

Saddle 30 also includes reinforcement ribs 38 located at the junction between top member 34 and back member 36. The reinforcement ribs 38 extend from top member 34 to back member 36. The reinforcement ribs 38 are oriented parallel to side dams 40a and 40b and to ridge 46b. The reinforcement ribs 38 resist wear by providing additional protection in the region most likely to be impacted by cookware. In one embodiment, the reinforcement ribs raise approximately one-tenth of an inch above the surface of top member 34 and back member 36. While the ribs reinforce and provide greater protection to the junction between the top member and the back member, the ribs do not impede the flow of water from the top surface of top member 34 into sink basin 12.

Back member 36 of saddle 30 includes four reinforced grommet holes 44a, 44b, 44c, and 44d, as shown for example in FIG. 5. Grommet holes 44 have a generally circular shaped portion 48 with a neck portion 49. Grommet holes 44 having additional material at the edge of the hole to strengthen or protect the opening from tearing. The neck portion 49 of holes 44 engages with a narrowed portion of stud 52, discussed below. These grommet holes 44 allow various components to be removably attached to saddle 30. FIG. 2 shows caddy 50 attached to saddle 30. Other components made also be attached to saddle 30 via the grommet holes 44. For example, two caddies may be attached to saddle 30.

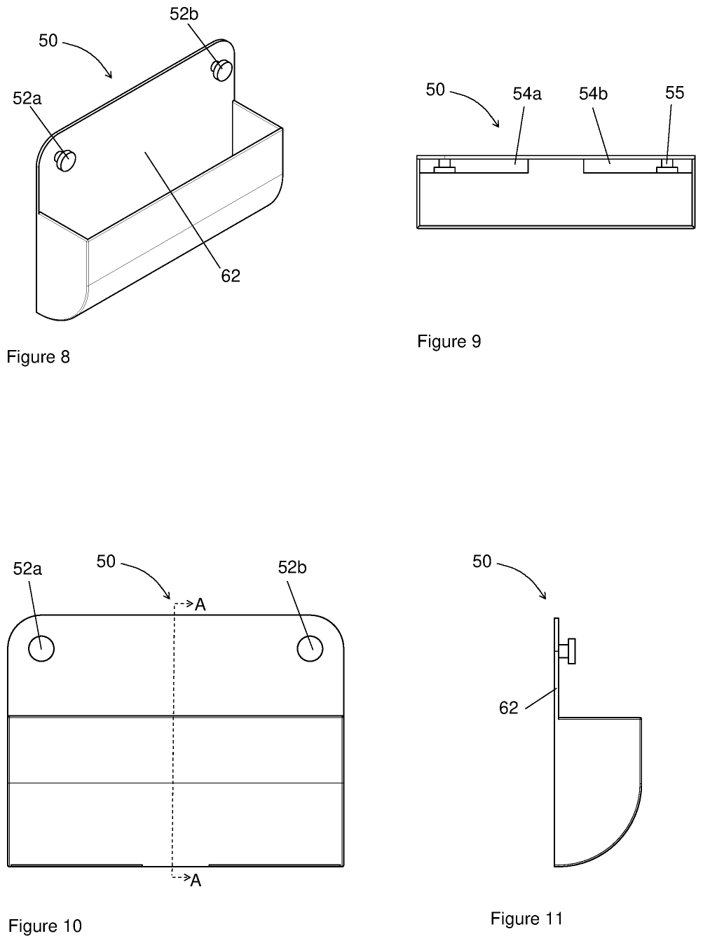

FIGS. 8-11 show the caddy 50 of FIG. 1. The caddy 50 is a component that can be removably attached to back member 36 of saddle 30, and provides a pocket for holding, e.g., a sponge. When in place, a flat back surface 62 of caddy 50 rests against the basin sidewall located opposite faucet 14.

Referring to FIGS. 8-11, the caddy 50 includes studs 52a and 52b, sized to mate with grommet holes 44. Studs 52 have a narrowed portion 55 that engages with neck portion 49 of holes 44 and locks the caddy in place allowing the caddy to hang from back member 36 into sink basin 12 as illustrated in FIGS. 1 and 2. The existence of two studs 52 and four grommet holes 44 allows caddy 50 to removably attached to saddle 30 in any of three different positions along back member 36 of saddle 30.

The bottom of caddy 50 includes two drain slots, 54a, 54b, which allow water to drain from caddy 50 into sink basin 12. For example, the drain slots 54a and 54b allow water from a sponge placed in caddy 50 to drain from the sponge into sink basin 12.

The saddle 30 is preferably made from a flexible, durable material, such as silicone. In one embodiment, saddle 30 is made from clear silicone Shore 70A hardness. Other types of silicones, including colored silicones, can be used.

Caddy 50 is preferably made from a more rigid material, such as polypropylene or polycarbonate. Other flexible materials, such as urethane or rubber, could also be used for either saddle 30, caddy 50, or both. Each of saddle 30 and caddy 50 can be made from a single mold.

The dimensions of top member 34 of saddle 30 are from 12 to 20 inches in length, approximately 4 inches in width, and with thicknesses between 0.05 and 0.125 inches. The dimensions can be adjusted to fit different sized front countertop portions 18. The height of front member 32 may be approximately 1 inch and the height of back member 36 may be approximately 3 inches.

Saddle 30 could also be manufactured and sold without the optional caddy 50, in which case grommet holes 44 would not be needed.

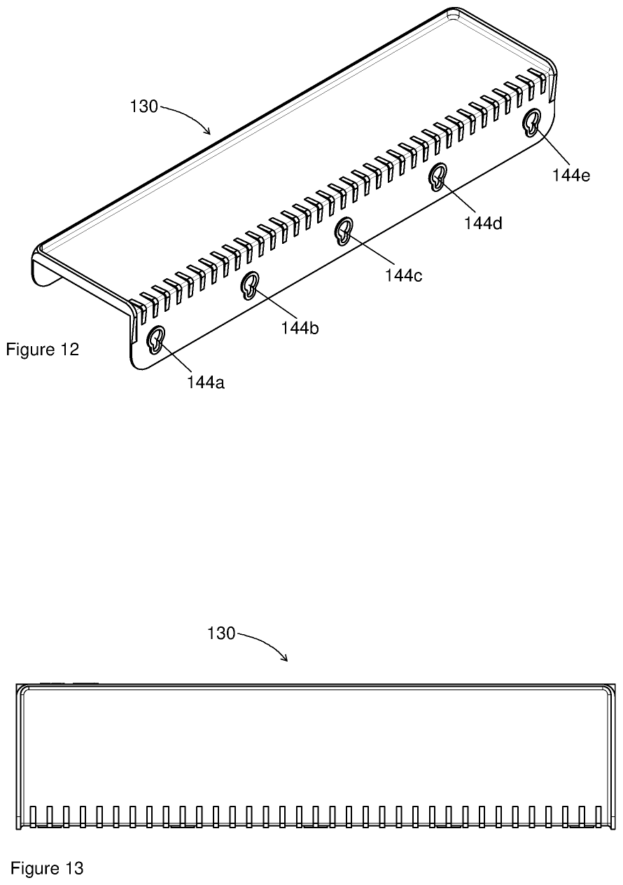

FIGS. 12 and 13 show an extra-long saddle 130 for use with wider sinks. Saddle 130 has five grommet holes 144a, 144b, 144c, 144d, and 144e, rather than four.

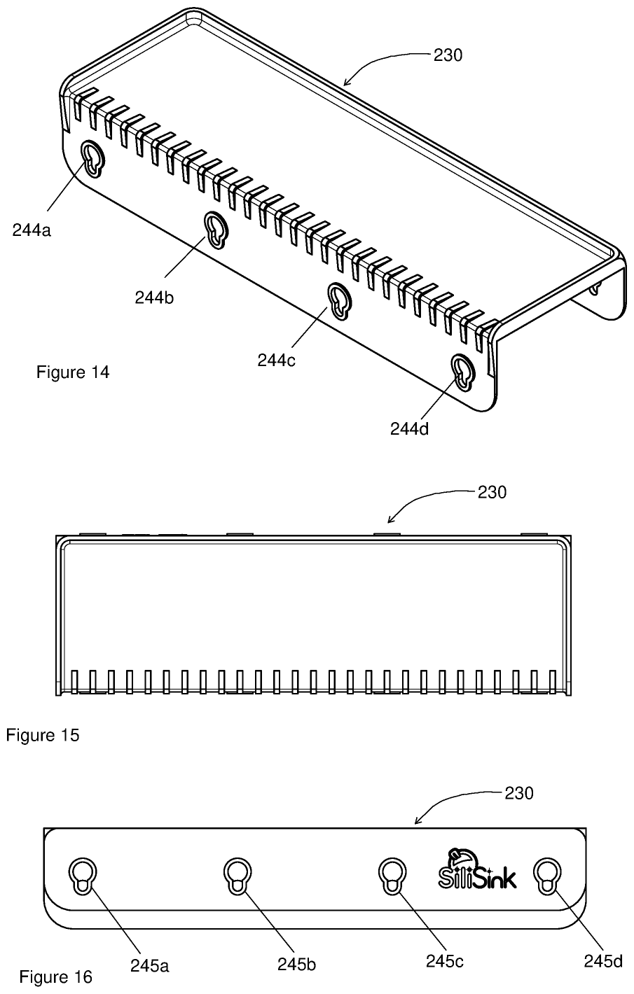

FIGS. 14, 15, and 16 show a third embodiment of the saddle, saddle 230. Saddle 230 has grommet holes on both sides. Specifically, saddle 230 includes grommet holes 244a, 244b, 244c, and 244d on back member of saddle 230. Holes 244a-244d are similar to holes 44a-d in saddle 30 and are intended to hold caddy 50. In addition, saddle 230 has grommet holes 245a, 245b, 245c, and 245d on the front member of the saddle. These holes would be outside the sink, facing away from the sink basin, when the saddle is positioned.

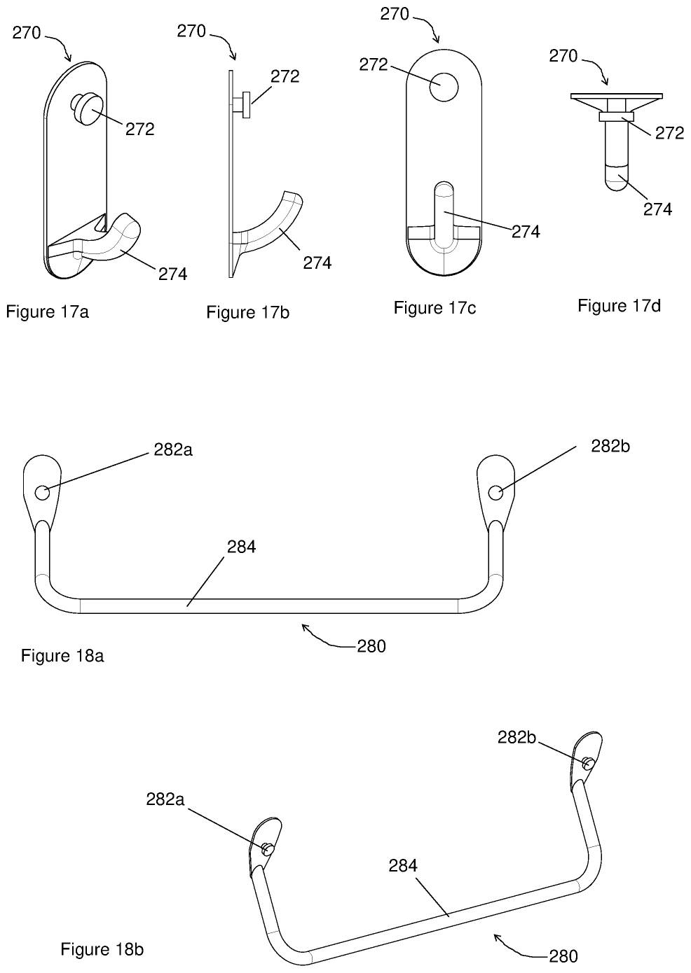

FIGS. 17a-17d show a towel hook 270 for use with saddle 30 or 230. Towel hook 270 includes stud 272 sized to mate with grommet holes 245a-245d, to attach towel hook 270 to the front member of saddle 230, or grommet holes 44a-44d, to attach towel hook 270 to the back member of saddle 30 or 230. Towel hook 270 also includes hook member 274 for holding a dish towel.

FIGS. 18a and 18b show a towel bar 280 for use with saddle 230. Towel bar 280 includes studs 282a and 282b sized to mate with grommet holes 245a-245d of saddle 230, and a bar member 284 sized and shaped to hold a dish towel. Towel bar attaches to saddle 230 similarly to towel hook 270 and provides an alternative mechanism for holding a towel.

While the invention has been described and illustrated herein with reference to a particular embodiment, it will be understood by those of skill in the art that changes to the details can be made without departing from the spirit and scope of the invention, as defined in the claims.

1-14. (canceled)

15. A device for protecting a countertop with an installed sink, the sink having a sink basin and a faucet, the sink basin having a length, the countertop having a front countertop portion running along an edge of the sink basin opposite the faucet, the device comprising:
a substantially flat top member having a width, a first edge, an oppositely positioned second edge, two side edges connecting the first and second edges, and a top surface, the width of the top member sized to substantially match a width of the front countertop portion perpendicular to the edge of the sink basin;
a substantially flat front member connected to the top member at the first edge of the top member, the front member and the top member forming an approximately 90-degree dihedral angle;
a substantially flat back member connected to the top member at the second edge of the top member, the back member and the top member forming an approximately 90-degree dihedral angle, the back member having a length sized to be less than the length of the sink basin and configured to lie substantially flat against a sidewall of the sink basin;
walls located along the first edge of the top member and along the two side edges of the top member; and
a ridge located along an edge of the back member, the ridge connected to the wall located along one of the two side edges of the top member.

16. The device of claim 15, wherein no wall is located along the second edge of the top member.

17. (canceled)

18. The device of claim 15 comprising:
a rib comprising a first segment disposed on the top surface of the top member and a second segment disposed on the back member, the rib being different from the ridge and the walls, the rib rising above the top surface of the top member and oriented parallel to the side edges of the top member.

19. The device of claim 15, wherein the top member, the back member, the front member, and the walls form a single molded piece.

20. The device of claim 19, wherein the single molded piece comprises silicone.

21. The device of claim 15, wherein the front member is configured to lie substantially flat against an edge of the countertop.

22. The device of claim 15, wherein the front member comprises grommet holes, each hole comprising a circular portion and a neck portion.

23. The device of claim 15, wherein the back member comprises grommet holes, each hole comprising a circular portion and a neck portion.

24. The device of claim 23 comprising:
a caddy configured to hold a sponge comprising a drainage hole and a stud, the stud inserted into one of the grommet holes in the back member, the stud having a narrowed portion that engages with the neck portion of the grommet hole.

25. (canceled)

26. (canceled)

27. A device for protecting a countertop with an installed sink, the sink having a sink basin and a faucet, the sink basin having a length, the countertop having a front countertop portion running along an edge of the sink basin opposite the faucet, the device comprising:
a substantially flat top member having a width, a first edge, an oppositely positioned second edge, two side edges connecting the first and second edges, and a top surface, the width of the top member sized to substantially match a width of the front countertop portion perpendicular to the edge of the sink basin;
a substantially flat front member connected to the top member at the first edge of the top member, the front member and the top member forming an approximately 90-degree dihedral angle;
a substantially flat back member connected to the top member at the second edge of the top member, the back member and the top member forming an approximately 90-degree dihedral angle, the back member having a length sized to be less than the length of the sink basin and configured to lie substantially flat against a sidewall of the sink basin, the back member comprising holes, each hole comprising a circular portion and a neck portion;
walls located along the first edge of the top member and along the two side edges of the top member and no wall located along the second edge of the top member;
a caddy configured to hold a sponge comprising a drainage hole and a stud, the stud inserted into one of the holes in the back member, the stud having a narrowed portion that engages with the neck portion of the hole; and
a ridge located along an edge of the back member, the ridge connected to the wall located along one of the two side edges of the top member.

28. The device of claim 27 comprising:
a rib comprising a first segment disposed on the top surface of the top member and a second segment disposed on the back member, the rib being different from the ridge and the walls, the rib rising above the top surface of the top member and oriented parallel to the side edges of the top member.

29. (canceled)

30. A device for protecting a countertop with an installed sink, the sink having a sink basin and a faucet, the sink basin having a length, the countertop having a front countertop portion running along an edge of the sink basin opposite the faucet, the device comprising:
a substantially flat top member having a width, a first edge, an oppositely positioned second edge, two side edges connecting the first and second edges, and a top surface, the width of the top member sized to substantially match a width of the front countertop portion perpendicular to the edge of the sink basin;
a substantially flat front member connected to the top member at the first edge of the top member, the front member and the top member forming an approximately 90-degree dihedral angle, the front member configured to lie substantially flat against an edge of the countertop, the front member comprising holes, each hole comprising a circular portion and a neck portion;
a substantially flat back member connected to the top member at the second edge of the top member, the back member and the top member forming an approximately 90-degree dihedral angle, the back member having a length sized to be less than the length of the sink basin and configured to lie substantially flat against a sidewall of the sink basin, the back member comprising holes, each hole comprising a circular portion and a neck portion;
walls located along the first edge of the top member and along the two side edges of the top member and no wall located along the second edge;
a ridge located along an edge of the back member, the ridge connected to the wall located along one of the two side edges of the top member;
a rib comprising a first segment disposed on the top surface of the top member and a second segment disposed on the back member, the rib being different from the ridge and the walls, the rib rising above the top surface of the top member and oriented parallel to the side edges of the top member;
wherein the top member, the back member, the front member, the walls, the ridge, and the rib form a single molded silicone piece;
a caddy configured to hold a sponge comprising a drainage hole and a stud, the stud inserted into one of the holes in the back member, the stud having a narrowed portion that engages with the neck portion of the hole; and
a towel hook component comprising a hook configured to allow a dish towel to hang from the hook and a stud, the stud inserted into one of the holes in the front member, the stud having a narrowed portion that engages with the neck portion of the hole; or
a towel bar component comprising a bar configured to allow a dish towel to hang from the bar and two studs, each stud inserted into one of the holes in the front member, each stud having a narrowed portion that engages with the neck portion of the hole.

31. A device for protecting a countertop with an installed sink, the sink having a sink basin and a faucet, the sink basin having a length, the countertop having a front countertop portion running along an edge of the sink basin opposite the faucet, the device comprising:
a substantially flat top member having a width, a first edge, an oppositely positioned second edge, two side edges connecting the first and second edges, and a top surface, the width of the top member sized to substantially match a width of the front countertop portion perpendicular to the edge of the sink basin;
a substantially flat front member connected to the top member at the first edge of the top member, the front member and the top member forming an approximately 90-degree dihedral angle;
a substantially flat back member connected to the top member at the second edge of the top member, the back member and the top member forming an approximately 90-degree dihedral angle, the back member having a length sized to be less than the length of the sink basin and configured to lie substantially flat against a sidewall of the sink basin;
walls located along the first edge of the top member and along the two side edges of the top member; and
a rib comprising a first segment disposed on the top surface of the top member and a second segment disposed on the back member, the rib being different from the ridge and the walls, the rib rising above the top surface of the top member and oriented parallel to the side edges of the top member.

32. The device of claim 31, wherein the top member, the back member, the front member, and the walls form a single molded piece.

33. The device of claim 32, wherein the single molded piece comprises silicone.

34. The device of claim 31, wherein the front member is configured to lie substantially flat against an edge of the countertop.

35. The device of claim 31, wherein the front member comprises grommet holes, each hole comprising a circular portion and a neck portion.

36. The device of claim 31, wherein the back member comprises grommet holes, each hole comprising a circular portion and a neck portion.

37. The device of claim 31, wherein no wall is located along the second edge of the top member.

38. A device for protecting a countertop with an installed sink, the sink having a sink basin and a faucet, the sink basin having a length, the countertop having a front countertop portion running along an edge of the sink basin opposite the faucet, the device comprising:
a substantially flat top member having a width, a first edge, an oppositely positioned second edge, two side edges connecting the first and second edges, and a top surface, the width of the top member sized to substantially match a width of the front countertop portion perpendicular to the edge of the sink basin;
a substantially flat front member connected to the top member at the first edge of the top member, the front member and the top member forming an approximately 90-degree dihedral angle;
a substantially flat back member connected to the top member at the second edge of the top member, the back member and the top member forming an approximately 90-degree dihedral angle, the back member having a length sized to be less than the length of the sink basin and configured to lie substantially flat against a sidewall of the sink basin; and
a dam wall located along the first edge of the top member and no dam wall is located along the second edge of the top member.

39. The device of claim 38, wherein the top member, the back member, the front member, and the dam wall form a single molded piece.

40. The device of claim 39, wherein the single molded piece comprises silicone.

41. The device of claim 38, wherein the front member is configured to lie substantially flat against an edge of the countertop.

42. The device of claim 38, wherein a length of the dam wall located along the first edge of the top member is substantially the same as a length of the first edge of the top member.
